(19) United States
(12) Patent Application Publication
(10) Pub. No.: US 2012/0018110 A1
(43) Pub. Date: Jan. 26, 2012

(54) FIBER ADDITIVE MADE FROM NON-WOODY MATERIAL AND METHOD OF PRODUCTION AND USE

(75) Inventor: Jianer Jiang, Mason, OH (US)

(73) Assignee: INTERNATIONAL PAPER COMPANY, MEMPHIS, TN (US)

(21) Appl. No.: 12/948,287

(22) Filed: Nov. 17, 2010

Related U.S. Application Data
(60) Provisional application No. 61/267,507, filed on Dec. 8, 2009.

(51) Int. Cl. D21H 13/10; C08K 5/00

(52) U.S. Cl. 162/148; 106/406

(57) ABSTRACT

A fibrillated fiber additive product and a process for making such fiber additives comprising the steps of providing a non-woody plant material, screening such material and subjecting the treated non-woody material to a refining step, such as through a disc refiner, to form a fibrillated fiber additive. Such refined non-woody fiber additive can be used to replace a portion of wood fiber, either virgin or recycled, in a paper product.

### FIELD OF THE INVENTION

This invention relates to fiber additives and more particularly, to a fiber additive formed from a non-woody plant material and a processes for forming the fiber additive of this invention and forming paper and paperboard products comprising the additive.

### BACKGROUND OF THE INVENTION

Products formed from a non-woody plant material such as corn-hull, oat hulls, and soy hulls are known in the art. See, for example U.S. Pat. Nos. 6,902,649; 7,074,300; and 5,023,103.

### SUMMARY OF THE INVENTION

One aspect of this invention is the development of a cost-effective paper additive from an abundant, low-cost waste fiber or byproduct that will replace higher cost virgin and old corrugated container (“OCC”) wood fibers in paper, particularly liner and medium grades. A further aspect is developing a process that makes such additive suitable for such uses, such that it has no impact or improved paper properties and no or low impact on paper production processes.

Still another aspect of this invention relates to a paper or paperboard comprising pulp and the fiber additive of this invention. The paper or paperboard of this invention includes one or more advantages which result from inclusion of the fiber additive of this invention. These advantages include improved paper bulk, bust, ring crush, tensile properties, or a combination of one or more thereof.

### BRIEF DESCRIPTION OF THE DRAWINGS

A full understanding of the invention can be gained from the following description of the preferred embodiments when read in conjunction with the accompanying drawings in which:

FIG. 1 is a schematic flow drawing illustrating the disclosed process of creating a fiber hull additive from corn fiber hulls.

FIG. 2 is a histogram illustrating percentage of rejects of screened CHA at different mesh sizes

FIG. 3 is a graph of the refining curve of screened corn hull fiber.

FIG. 4 is a graph of particle size versus refining energy of corn hull fiber.

FIG. 5 is a histogram of Short Span Compression Strength (STFI) of corn hull fiber additive samples plus a control.

FIG. 6 is a histogram of tensile strength of corn hull fiber additive samples plus a control.

FIG. 7 is a histogram of apparent density of corn hull fiber additive samples plus a control.

FIG. 8 is a bar graph of ring crush and Mullen Index properties of corn hull fiber additives versus a control.

### DETAILED DESCRIPTION OF THE INVENTION

While this invention is susceptible of embodiment in many different forms, there is shown and described in drawing, figures, and examples and will herein be described in detail preferred embodiments of the invention with the understanding that the present disclosure is to be considered as an exemplification of the principles of the invention and is not intended to limit the broad aspect of the invention to the embodiments illustrated.

As used herein, “specific surface area” is determined by a procedure utilizing the widely used TAPPI Standard Method T-226 cm-82. As used herein, “freeness” is determined by TAPPI Standard Methods T 220 sp-06.

One embodiment of the invention is directed to the formation of a fiber additive formed from non-woody plant material. As used herein the term “non-woody plant material” refers to a non-wood fiber (NWF) obtained from plants other than wood. Examples of such plants are those described in James S. Han, “Properties of Nonwood Fibers” 1998 Proceeding of the Korean Society of Wood Science and Technology Annual meeting. Illustrative of such plants material are from grains, such as corn hulls (pericarp), soybean hulls, oat bran, wheat, rice and other grain-derived materials. Another embodiment of the invention is the use of such fiber additive in paper, such as linerboard and medium for use in constructing corrugated board.

Typical chemical composition of corn-hull, oat hulls, and soy hulls used in the manufactured of the fiber additive of this invention are set forth in the following Table 1.

TABLE 1
Carbohydrate Compositions of Starting Raw Materials

| | | | | | | | | Hemicellulose | Glucose/ |
|---|---|---|---|---|---|---|---|---|---|
| | Carbohydrates, % OD Sample Weight | | | | | | | Total | Hemicellulose |
| | Arabinan | Galactan | Glucan | Xylan | Mannan | Hemi | Total | Ratio | Ratio |
| Corn Hulls | 12.4 | 3.5 | 29.1 | 21.8 | 0.9 | 38.6 | 67.7 | 0.57 | 0.8 |
| | 13.8 | 3.8 | 27.7 | 22.9 | 0.8 | 41.3 | 69.0 | 0.60 | 0.7 |
| | 10.4 | 2.9 | 31.8 | 16.7 | 0.9 | 30.9 | 62.7 | 0.49 | 1.0 |
| Oat Hulls | 3.3 | 1.4 | 33.1 | 29.2 | 0.1 | 34.0 | 67.1 | 0.51 | 1.0 |
| | 3.8 | 1.2 | 34.9 | 30.8 | 0.1 | 35.9 | 70.8 | 0.51 | 1.0 |
| Soy Hulls | 4.8 | 3.1 | 36.8 | 8.2 | 6.1 | 22.2 | 59.0 | 0.38 | 1.7 |
| | 3.8 | 3.4 | 35.8 | 7.8 | 5.8 | 20.8 | 56.6 | 0.37 | 1.7 |
| | 3.7 | 3.3 | 36.4 | 7.7 | 5.9 | 20.6 | 57.0 | 0.36 | 1.8 |

The fiber additive includes a variety of polymers in its chemical composition, including cellulose, hemicellulose and lignin. “Cellulose” is a linear polymer of glucose that forms a “backbone” structure of most plant fibers. Hydrogen bonding between cellulose polymers confers high strength to cellulose fibers. “Hemicellulose” refers to a class of polymers of sugars including the six-carbon sugars mannose, galactose, glucose, and 4-O-methyl-D-glucuronic acid and the five-carbon sugars xylose and arabinose. Hemicellulose polymers are essentially linear, except for single-sugar side chains and acetyl substituents. Hemicellulose polymers are more soluble and labile than cellulose and can be solubilized from plant cell walls using alkali, such as sodium hydroxide. “Holocellulose” is a term that refers to the total cellulose and hemicellulose content in plant fiber. “Lignin” is a complex polymer of phenoxypropanol units that is thought to have an amorphous, three-dimensional structure. Lignin functions as is an adhesive or binder that holds the fibers together in plants.

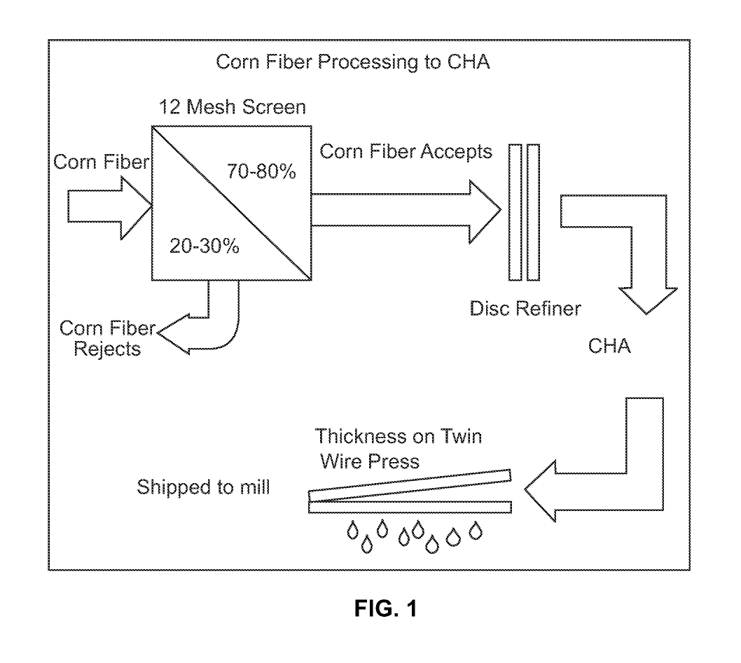

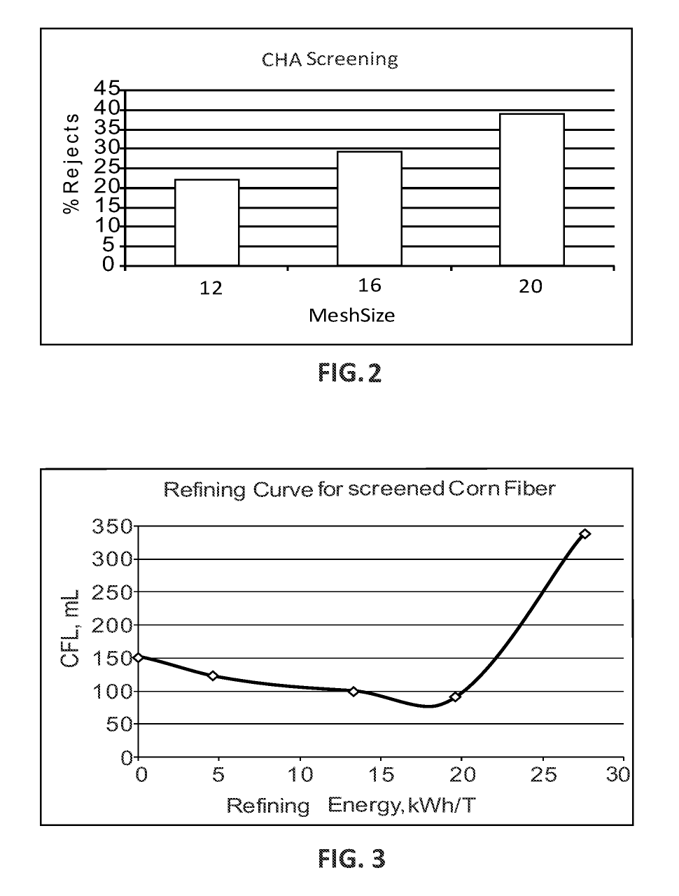

Referring to FIG. 1, a method of processing corn hull fibers into an additive is illustrated. Corn hull fiber, commonly produced as a byproduct of corn wet milling processes is passed through a 12 mesh screen. Approximately 70-80% of the fibers pass through the screen and are accepted. The remaining 20-30% of large material is rejected and returned to the wet milling process. It was found that 12 mesh screening produced the optimal amount of “acceptable” fibers. At 16 and 20 mesh, the number of rejects increased by an additional 10 to 20%. See FIGS. 2 and 3.

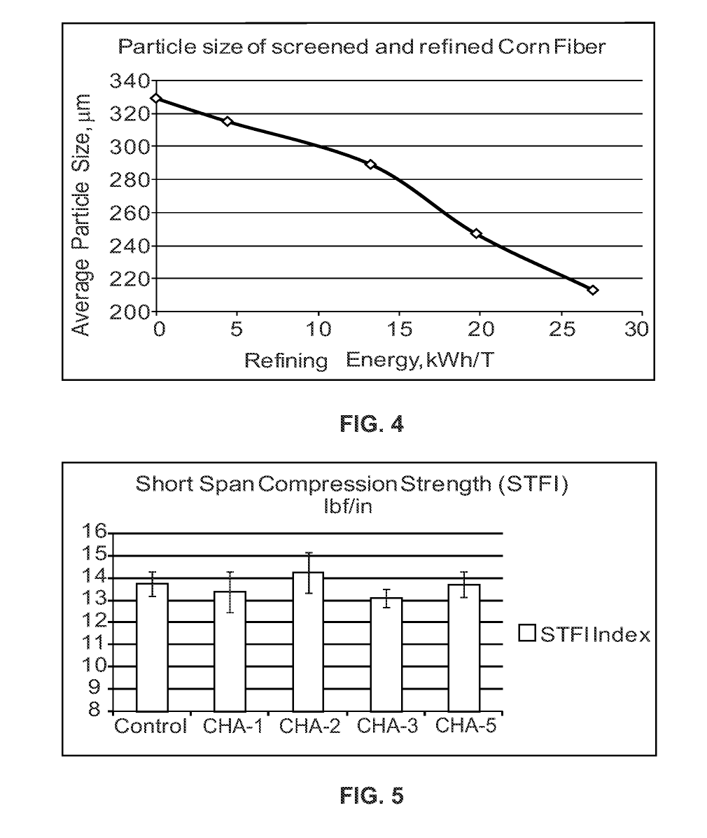

The accepts are refined by a disc refiner at 20 kWh/T and 6% solids to yield a (corn hull) fiber additive (“CHA”) with a freeness 90-100 mL CSF. Average particle size was approximately between 240-250 μm—See FIG. 4.

The CHA is thickened on a twin wire press to yield 20% solids. Some fines are lost during the pressing step. The resulting, thickened CHA is then sent to the paper mill for use as an additive, as further described below.

Preferably, the additive particle has an irregular shape. As used herein “irregular shape” means that the fiber additive does not have a symmetrical shape. It has been found that the small fibril shape of the CHA fibers is similar to chemical pulp such as hardwood fibers and fines.

A summary physical characteristics of the corn hull fiber for use in this process is summarized below, indicating preferred, more preferred and most preferred characteristics set forth in Table 1, below.

TABLE 1

| | Size | | Morphology | Composition | Performance |
|---|---|---|---|---|---|
| General | >400 | mesh, | Irregular | Lignin: 3-15% | Similar to wood |
| | <16 | mesh | | Cellulose: ≦60% | fibers with a |
| | | | | Hemicelluloses: ≧20% | large number of |
| | | | | | fines |
| Preferred | >140 | mesh, | 50% with | Lignin: 3-15% | Some increases in |
| | <16 | mesh | length/width | Cellulose: ≦60% | one or more of |
| | | | ratio: >5, | Hemicelluloses: ≧20% | paper bulk, burst, |
| | | | fibrillated | | ring crush and |
| | | | | | tensile properties |
| More Preferred | >35 | mesh, | >50% with | Lignin: 3-12% | Significant |
| | <16 | mesh | length/width | Cellulose: ≦55% | increases in one |
| | | | ratio: >10, | Hemicelluloses: ≧30% | or more of paper |
| | | | fibrillated | | bulk, burst, ring |
| | | | | | crush and tensile |
| | | | | | properties |
| Most Preferred | >35 | mesh, | >50% with | Lignin: 3-12% | Significant |
| | <16 | mesh | length/width | Cellulose: ≦55% | increases in two |
| | | | ratio: >15, | Hemicelluloses: ≧30 | or more of paper |
| | | | fibrillated | | bulk, burst, ring |
| | | | | | crush and tensile |
| | | | | | properties |

In the preferred embodiments at least about 50% of the particle has an aspect ratio of equal to or greater than about 5. As used herein “aspect ratio” means the ratio of the length, which is the largest dimension of a particle to its width or diameter, which can be determined by the procedure of using one of the fiber analyzers such as an FQA(fiber quality Analyzer) instrument marketed by Optec Inc. or a kajaani fiber analyzer marketed by Metso Corp.

The aspect ratio is equal to or greater than about 5, more preferably equal to or greater than about 10, most preferably is equal to or greater than about 15. In the embodiment of choice the aspect ratio is equal to or greater than about 20 and more preferably equal to or greater than 25.

In a preferred embodiment of this invention the fiber additive is fibrillated. As used herein “fibrillated” means having threadlike fine fibrils on the external surface of the particles and visible under an optical microscope at 30× magnification. These fibrils are small hair-like structures branching out of the particle surface and about one order of magnitude smaller in size than the paper additive particles. The degree of fibrillazation is generally estimated by optical observation and can be usually inferred by the specific area and/or the freeness of the fiber additive.

In the preferred embodiments, the amount of lignin is from about 3% to about 15% by weight, the amount of cellulose is equal to or less than about 60% by weight and the amount of hemicellulose is equal to or greater than about 20% by weight, wherein all wt % are based on the total weight of the fiber additive. The ISO brightness of the paper is at least 80 GE.

In general, the specific surface area of fiber additive is at least about 0.1 m²/g. The specific surface area of the fiber additive is preferably from about 0.1 to about 50 m²/g, more preferably from about 0.2 to about 20 m²/g and most preferably, 0.3 to about 10 m²/g.

In general, the freeness of fiber additive is at least about 30 mL. The freeness of the fiber additive is preferably from about 100 to about 750 mL, more preferably from about 250 to about 750 mL and most preferably 450 to about 650 mL.

The average length of the fiber additive may vary widely and is determined by a procedure using a fiber analysis instrument such as an FQA described therein above. The additive length is preferably equal to or less that about 5 mm, more preferably equal to about 0.1 to about 3.5 mm, and most preferably equal to about 0.5 to about 1.5 mm.

### Use in Manufacturing Paper

Another aspect of this invention relates to a paper and paperboard product comprising pulp fibers and fiber additive of this invention. Useful fiber additives and the preferred, the more preferred, and the most preferred fiber additive are described herein above and will not be described in this section.

The amount of fiber additive included in a paper and paperboard can vary widely to obtain a desired effect. In general, the greater amount of fiber additive, particularly the most preferred type, included in the paper or paperboard, the greater the impact on properties such as brightness, bulk, burst, ring crush, smoothness, strength and combinations of two or more thereof. Typically the amount the fiber additive can be as low as about 1 wt % and as high as about 60 wt %, each based on the total weight of the paper or paperboard. The amount of additive is preferably from about 2 to about 40 wt %, more preferably from about 3 to about 30 wt %, and most preferably from about 5 to about 20 weight % on the aforementioned basis.

Any pulp can be used in the process of this invention as for example those used in conventional papermaking Illustrative of such pulp fibers are those derived from hardwood trees, softwood trees, or a combination of hardwood and softwood trees prepared for use in a papermaking furnish by any known suitable digestion, refining, and bleaching operations as for example known mechanical, thermomechanical, chemical and semichemical, etc., pulping and other well known pulping processes. In certain embodiments, at least a portion of the pulp fibers may be provided from non-woody herbaceous plants including, but not limited to, straws of wheat and rice, kenaf, hemp, jute, flax, sisal, or abaca although legal restrictions and other considerations may make the utilization of hemp and other fiber sources impractical or impossible. Either bleached or unbleached pulp fiber may be utilized in the process of this invention. Recycled pulp fibers are also suitable for use. In a preferred embodiment, the cellulosic fibers in a paper product include from about 30% to about 100% by weight dry basis softwood fibers and from about 70% to about 0% by weight dry basis hardwood fibers.

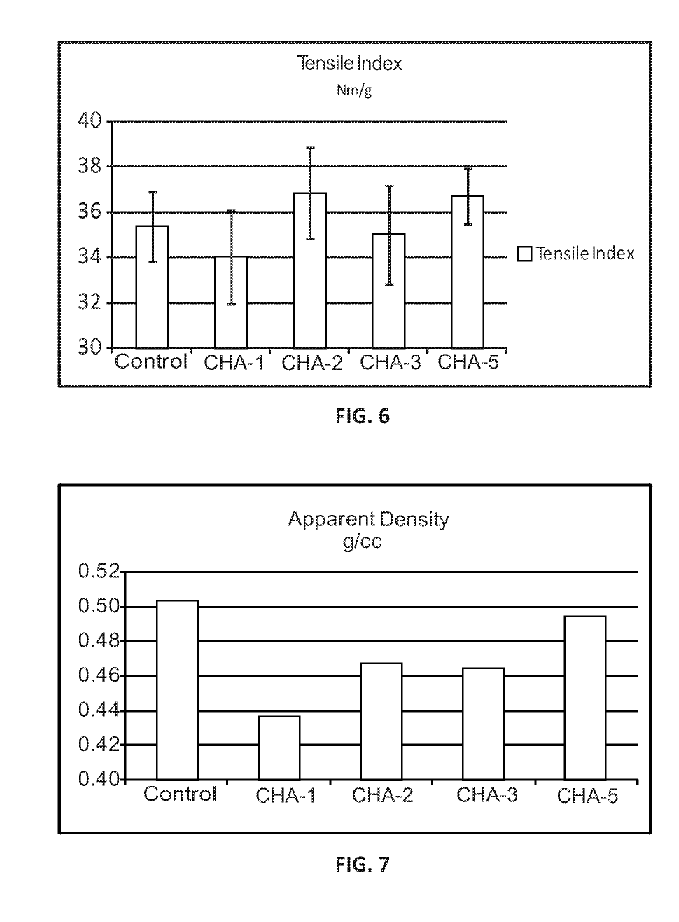

The fiber additive, in the aforementioned examples CHA, is mixed with virgin wood fibers, recycled fiber (such as old corrugated container “OCC” fibers) or both. In one example, 10% CHA, produced as outlined above, was added to OCC and co-refined. The fiber mix is then utilized to make paper, particularly liner paper for corrugated containers, in conventionally or otherwise developed papermaking methods. No significant impacts or changes in paper machine operations were observed through the use of the fiber blend containing the CHF. The preferable range of wood fiber replacement using CHA or other non-woody additive made under the process outlined herein is 10-15%, although lesser amounts may be used. The use of the fiber additive does not dramatically affect short span compression strength or tensile strength of the paper (See FIGS. 6 and 7).

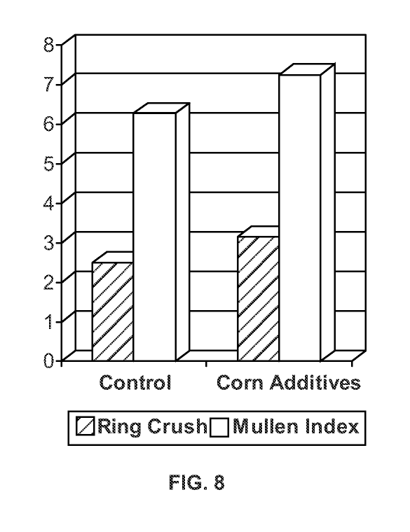

The fiber replacement also increases bulk and additional refinement increases density (see FIG. 8).

The resulting paper further showed increases in burst strength and ring crush, as is shown in Table 2, below, and FIG. 8.

TABLE 2

| Sample | Control | Test | Difference |
|---|---|---|---|
| Corn Hull Additive, % | 0 | 7.5 | — |
| Basis weight, g/m² | 150 | 147 | −1.6% |
| Bulk, cm³/g | 1.48 | 1.52 | 2.5% |
| Roughness | 227 | 209 | −8.0% |
| TAPPI Brightness, % | 14.0 | 14.5 | 3.3% |
| Burst Index, kPa · m²/g | 6.5 | 7.3 | 12.4% |
| Ring Crush, kN/m | 2.8 | 3.3 | 16.9% |

The paper or paperboard of this invention can be manufactured using conventional processes and apparatus which are well know to one ordinary skill in the art and will not be described herein in great detail. See for example “Handbook For Pulp & Paper Technologies”, 2^{nd} Edition, G.A. Smook, Angus Wilde Publications (1992) and references cited therein.

Preferably the process comprises: a) providing an aqueous pulp suspension; b) sheeting and drying the aqueous pulp suspension to obtain dried paper or paperboard web; c) treating the dried paper or paper or paperboard web by applying to at least one surface of the paper or paperboard a size composition containing one or more hydrophobic polymers and starch to form a treated paper or paperboard web; and d) drying the paper to obtain sized paper or paperboard web.

In step a) of the preferred embodiment of this invention, an aqueous pulp suspension is provided. Methods of forming aqueous pulp suspensions are well known in the paper and paperboard art and will not be described in any great detail. See for example G.A. Smook referenced above and references cited therein. Any conventional aqueous pulp suspensions method can be used. The cellulosic fibrous component of the furnish is suitably of the chemically pulped variety, such as a bleached kraft pulp, although the invention is not believed to be limited to kraft pulps, and may also be used with good effect with other chemical pulps such as sulfite pulps, mechanical pulps such as ground wood pulps, and other pulp varieties and mixtures thereof such as chemical-mechanical and thermo-mechanical pulps.

In step (b) of the process of this invention, the pulp suspension of step (a) is sheeted and dried to obtain dried paper or paperboard web. Methods and apparatuses for sheeting and drying a pulp suspension are well known in the paper and paperboard art. See for example G.A. Smook referenced above and references cited therein. Any conventional sheeting and drying method can be used. Consequently, these methods will not be described herein in any great detail.

In step (c) of the process of this invention, the dried paper or paper or paperboard web is treated by applying to at least one surface of the paper or paperboard a size composition comprising one or more starches and other size press additives. The starch may be of any type, including but not limited to oxidized, ethylated, cationic and pearl, and is preferably used in aqueous solution. Illustrative of useful starches for the practice of this preferred embodiment of the invention are naturally occurring carbohydrates synthesized in corn, tapioca, potato and other plants by polymerization of dextrose units. All such starches and modified forms thereof such as starch acetates, starch esters, starch ethers, starch phosphates, starch xanthates, anionic starches, cationic starches and the like which can be derived by reacting the starch with a suitable chemical or enzymatic reagent can be used in the practice of this invention.

Preferred starches for use in the practice of this invention are modified starches. More preferred starches are cationic modified or non-ionic starches such as CatoSize 270 and KoFilm 280 (all from National Starch) and chemically modified starches such as PG-280 ethylated starches and AP Pearl starches. More preferred starches for use in the practice of this invention are cationic starches and chemically modified starches.

In addition to the starch, small amounts of other additives may be present as well in the size composition. These include without limitation dispersants, fluorescent dyes, surfactants, deforming agents, preservatives, pigments, binders, pH control agents, coating releasing agents, optical brighteners, defoamers and the like.

Methods and apparatuses for treating a dried paper or paperboard of paper or paperboard with a sizing composition are well known in the paper and paperboard art. See for example “Handbook For Pulp & Paper Technologies”, 2^{nd} Edition, G.A. Smook, Angus Wilde Publications (1992) and references cited therein. Any conventional size treatment method and apparatus can be used. Consequently, these methods and apparatuses will not be described herein in any great detail. By way of example, the size composition may be applied from a size press that can be any type of coating or spraying equipment, but most commonly is a puddle, gate roller or metered blade type of size press.

In step (d) of the preferred embodiment of the process of this invention, the paper or paperboard web is dried after treatment with the size composition. Methods and apparatuses for drying paper or paperboard webs treated with a sizing composition are well known in the paper and paperboard art. See for example G.A. Smook referenced above and references cited therein. Any conventional drying method and apparatus can be used. Consequently, these methods and apparatuses will not be described herein in any great detail. After drying, the paper may be subjected to one or more post drying steps as for example those described in G.A. Smook referenced above and references cited therein. For example, the paper or paperboard web may be coated and/or calendared to achieve the desired final caliper as discussed above to improve the smoothness and other properties of the paper or paperboard. The calendaring may be accomplished by steel-steel calendaring at nip pressures sufficient to provide a desired caliper. It will be appreciated that the ultimate caliper of the paper ply will be largely determined by the selection of the nip pressure.

As briefly referenced above, the paper or paper product of this invention exhibits one or more beneficial properties. For example, certain embodiments of paper or paperboard of this invention exhibits improved bulk as compared to paper or paperboard which do not include the fiber additive. Bulk can be determined by procedure of TAPPI-220 sp-06. In the preferred embodiment of this invention the paper or paperboard will exhibits bulk which is greater than the burst properties of the same or substantially the same paper or paperboard which does not include the fiber additive of this invention. In these preferred embodiments, the improvement in bulk is at least by about 2%, preferably by about 4%, more preferably by 6% and most preferably by 8%.

For example, certain embodiments of paper or paperboard of this invention exhibits improved burst properties as compared to paper or paperboard which do not include the fiber additive. Burst strength is readily measured by TAPPI-220 sp-06. In the preferred embodiment of this invention the paper or paperboard will exhibits burst properties which is greater than the burst properties of the same or substantially the same paper or paperboard which does not include the fiber additive of this invention. In these preferred embodiments, the improvement in burst properties is at least by about 2%, preferably by about 4%, more preferably by 6% and most preferably by 8%.

Certain embodiments of paper or paperboard of this invention exhibits improved Mullen Index as compared to paper or paperboards which do not include the fiber additive. Mullen Index is determined by procedure of TAPPI-818 cm-97. In the preferred embodiments of this invention the paper or paperboard will exhibits a Mullen Index which is greater than the Mullen Index of the same or substantially the same paper or paperboard which does not include the fiber additive of this invention. In these preferred embodiments the improvement in Mullen Index is at least by about 4%, preferably by about 6%, more preferably by about 8% and most preferably by about 10%.

Embodiments of paper or paperboard of this invention exhibits improved burst properties as compared to paper or paperboard which do not include the fiber additive. Burst strength and other paper properties are readily measured by TAPPI-220 sp-06. In the preferred embodiment of this invention the paper or paperboard will exhibits burst properties which is greater than the burst properties of the same or substantially the same paper or paperboard which does not include the fiber additive of this invention. In these preferred embodiments, the improvement in burst properties is at least by about 2%, preferably by about 4%, more preferably by 6%, most preferably by 8%.

For example, in preferred embodiments of this invention the paper or paperboard will exhibits a ring crush which is greater than the ring crush of the same or substantially the same paper or paperboard which does not include the fiber additive of this invention. Ring crush is determined by procedure of TAPPI-818 cm-97. In these preferred embodiments, the improvement in ring crush is at least by about 4%, preferably by about 6%, more preferably by about 8% and most preferably by about 10%.

Embodiments of paper or paperboard of this invention exhibits improved smoothness as compared to paper or paperboard which does not include the fiber additive. In the preferred embodiment of this invention the paper or paperboard will exhibits smoothness greater than the smoothness of the same or substantially the same paper or paperboard which does not include the fiber additive of this invention. Smoothness is readily measured by TAPPI-220 sp-06 or other well accepted standard methods. In these preferred embodiments, the improvement in smoothness is at least by about 2%, preferably at least by about 4%, more preferably at least by about 6% and most preferably by at least about 8%.

For example, certain embodiments of paper or paperboard of this invention exhibits improved caliper as compared to paper or paperboard which do not include the fiber additive. Caliper is readily measured by TAPPI-220 sp-06 or other well accepted standard methods. In these preferred embodiments, the improvement in caliper is at least by about 1%, preferably at least by about 1.5%, more preferably by at least 2% and most preferably at least by 2.5%.

### Additional Additives

In alternative embodiments of the invention, in addition to pulp fibers and optional additives, the paper or paperboard web also includes dispersed within the fibers and any other components expanded microspheres. Experimentation has shown that the combination of microspheres and hydrophobic polymer provides a paper or paperboard web and product made therefrom exhibiting even greater improvements in water resistance than the starch and hydrophobic polymer alone. Expanded and expandable microspheres are well known in the art. See for example Expandable microspheres are described in co pending application Ser. No. 09/770,340 filed Jan. 26, 2001 and Ser. No. 10/121,301, filed Apr. 11, 2002 and U.S. Pat. Nos. 3,556,934, 5,514,429, 5,125,996, 3,533,908, 3,293,114, 4,483,889, and 4,133,688; and UK Patent Application 2307487, the contents of which are incorporated by reference. All such microspheres can be used in the practice of this invention.

### Benefits

The use of a fiber replacement has several benefits to the papermaker. There is a fiber cost savings and addresses potential, long-term fiber constraints and volatility in raw materials. Of course, such additives present opportunities to increase the sustainability profile of paper and paper products. Corn hull fiber from corn wet-milling is the preferred material due to year-round supply and possible federal funding for use of a renewable biomass. The corn producer benefits through energy savings—reduced fiber drying—and mix improvement in the availability of higher protein content feed.

This suggests that the less preferred paper additives can be used as pine fiber substitute, which could result in cost saving when the paper additives are less costly than own-made or purchased pine fibers and offer incremental production profits when a paper mill is fiber limited. The results also show that this type of less preferred paper additives are better than paper fillers, which are typically of inorganic nature and which almost always lower paper strength.

Various modifications and variations may be devised given the above-described embodiments of the invention. The paper manufactured in accordance with this invention can be used for conventional purposes. For example, the paper is useful as printing paper, cartons, packaging, publication paper, newsprint, linerboard and the like. It is intended that all embodiments and modifications and variations thereof be included within the scope of the invention as it is defined in the following claims.

What is claimed is:

1. A process of making fiber additives from a non-woody material, the process comprising the steps of:
a) Providing a non-woody material;
b) Screening said non-woody material through a screen between about 12 to 16 mesh;
c) refining the screened non-woody material at about 20 kWh/T and about 6% solids to form a fibrillated fiber having a freeness between about 90-100 CSF.

2. The process of making fiber additives according to claim 1 further comprising the step of thickening the refined, fibrillated fiber on a twin wire press to yield about 20% solids.

3. The process of making fiber additives according to claim 1 wherein the non-woody material comprises corn hull fiber.

4. The process of making fiber additives according to claim 1 wherein the refining step includes refining the non-woody material using a disc refiner.

5. A process for making fiber additives from a non-woody material, the process comprising the steps of:
Providing a non-woody material;
Screening said non-woody material and Refining the non-woody material at a high shear force to form a fibrillated fiber.

6. A paper formed from a wood pulp and a fiber additive, the fiber additive being fibrillated and having a freeness between about 90-100 CSF comprising a non-woody material screened through a screen between about 12 to 16 mesh, refined at about 20 kWh/T and about 6% solids, and thickened to yield about 20% solids.

7. The paper of claim 6 wherein the fiber additive is from about 3 to 40% by weight of the paper.

8. The paper of claim 6 wherein the paper is liner paper for corrugated board.

9. The paper of claim 6 wherein the wood pulp comprises virgin wood fibers, recycled wood fibers or a mixture thereof.

10. The paper according to claim 6 wherein the non-woody material comprises corn hull fiber.
